(19) United States
(12) Patent Application Publication
(10) Pub. No.: US 2013/0002516 A1
(43) Pub. Date: Jan. 3, 2013

(54) RECEIVING APPARATUS

(75) Inventor: Tadashi Kosuga, Kawagoe (JP)

(73) Assignee: PIONEER CORPORATION, Kanagawa (JP)

(21) Appl. No.: 13/634,556

(22) PCT Filed: Mar. 26, 2010
(86) PCT No.: PCT/JP2010/055355

§ 371 Date: Sep. 13, 2012

(51) Int. Cl. H01Q 3/24

(52) U.S. Cl. 343/876

(57) ABSTRACT

A switching diode 33 interposed in a signal line L31 which is a signal route from an antenna 1, and a switching diode 34 interposed in a signal line L32 which is a signal route from an antenna 2 are provided in an antenna unit 3, and the signal line L31 and the signal line L32 are connected after the switching diodes 33 and 34 are interposed, and then, are connected to a coaxial cable 4, and switching on and off of the switching diode 34 depends on a direction of a direct current flowing in the coaxial cable 4, and has an inverse relationship from each other to control the direction of the direct current flowing in the coaxial cable 4 by a control circuit 53 provided in a tuner unit 5.

### TECHNICAL FIELD

The present invention relates to a technical field of a receiving apparatus which has an antenna unit which receives inputs of signals from a plurality of antennas, and a tuner unit which receives a signal outputted from the antenna unit through a coaxial cable.

### BACKGROUND ART

As a receiving apparatus of this type, a diversity receiver is known which is mounted on, for example, a moving vehicle. With a conventional diversity receiver, an antenna unit has each antenna amplifier associated with each antenna. Each antenna amplifier amplifies a signal received at a corresponding antenna. Further, the signal amplified by each antenna amplifier is inputted to a tuner unit through a corresponding coaxial cable. Meanwhile, the tuner unit has, for example, a control switching element and a diversity control unit which support each coaxial cable. The diversity control unit performs switching control of the antennas by detecting reception quality and switching on one of the above control switching elements.

However, this configuration requires the same number of coaxial cables as the number of antennas, and therefore causes inconvenience in terms of cost and a wiring operation.

By contrast with this, a technique disclosed in Patent Literature 1 can reduce the number of signal lines between antenna amplifiers and tuners by providing a circuit for switching between two antennas on an antenna amplifier side.

### CITATION LIST

### Patent Literature

Patent Literature 1: Japanese Patent Application Laid-Open No. 2004-172884

### SUMMARY OF THE INVENTION

### Problem to be Solved by the Invention

However, as disclosed in Patent Literature 1, even when a circuit for switching between a plurality of antennas is provided on an antenna amplifier side, a signal line for transmitting a predetermined control signal (diversity switch signal S2 in Patent Literature 1) from a tuner to an antenna amplifier is required, and therefore causes inconvenience in terms of cost and a wiring operation.

Therefore, as an example of an object to solve this inconvenience, an object of the present invention is to provide a receiving apparatus which can reduce the number of coaxial cables for transmitting signals received at a plurality of antennas from an antenna unit to a tuner unit without requiring a signal line for transmitting a predetermined control signal from the tuner unit to the antenna unit.

### Means for Solving the Problem

In order to solve the above problem, the invention according to claim 1 is a receiving apparatus comprising:

an antenna unit which receives inputs of signals received at a plurality of antennas; and

a tuner unit which receives an input of a signal outputted from the antenna unit through a coaxial cable,

wherein the antenna unit comprises:

a first circuit which is connected to a first antenna;

a second circuit which is connected to a second antenna;

a first switching element which is interposed in a first signal line connected to an output terminal of the first circuit, and which switches between conduction and non-conduction of the first signal line by way of switching on and off;

a second switching element which is interposed in a second signal line connected to an output terminal of the second circuit, and which switches between conduction and non-conduction of the second signal line by way of switching on and off; and

a connecting unit which connects the first signal line and the second signal line after each of the switching elements is interposed, and which is connected to the coaxial cable,

the switching on and off of the first switching element and the second switching element depends on a direction of a direct current flowing in the coaxial cable, and has an inverse relationship from each other, and

the tuner unit is connected to a third signal line which connects the coaxial cable and a tuner, and comprises a control circuit which controls the direction of the direct current flowing in the coaxial cable.

### BRIEF DESCRIPTION OF DRAWINGS

FIG. 1 illustrates a view that illustrates a configuration example of a diversity receiver according to the present embodiment.

FIG. 2A illustrates a view that illustrates a route of a direct current flowing in a circuit in a diversity receiver R when a transistor 53c is in an on state.

FIG. 2B illustrates a view that illustrates a route of a direct current flowing in a circuit in the diversity receiver R when the transistor 53c is in an off state.

FIG. 3 illustrates a view that illustrates a configuration example of the diversity receiver when transistors are adopted as first and second switching elements.

### MODE FOR CARRYING OUT THE INVENTION

Hereinafter, an embodiment of the present invention will be described with reference to the accompanying drawings. In addition, the embodiment will be described where a receiving apparatus according to the present invention is applied to a diversity receiver such as a radio.

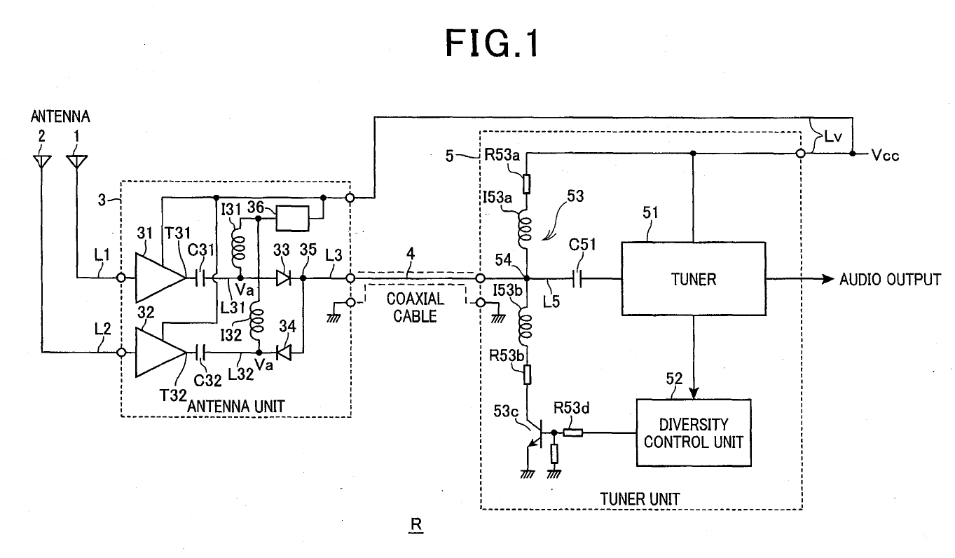

First, a configuration and a function of the diversity receiver according to the present embodiment will be described with reference to FIG. 1. In addition, the diversity receiver according to the present embodiment is mounted in a moving vehicle such as a car.

FIG. 1 is a view that illustrates a configuration example of the diversity receiver according to the present embodiment.

As illustrated in FIG. 1, a diversity receiver R according to the present embodiment is configured to include an antenna 1 (an example of a first antenna), an antenna 2 (an example of a second antenna), an antenna unit 3, a coaxial cable 4 and a tuner unit 5.

In addition, the antenna unit 3 and the tuner unit 5 are physically separated, and installed at, for example, different sites in a moving vehicle. Further, the antenna unit 3 and the tuner unit 5 receive a supply of power from a power source Vcc through a power source line Lv.

The antenna unit 3 receives inputs of signals (high frequency signals related to airwaves) broadcasted from a broadcasting station and received at the antennas 1 and 2. The antenna unit 3 has, for example, an antenna amplifier 31, an antenna amplifier 32, a switching diode 33 (an example of a first switching element) and a switching diode 34 (an example of a second switching element).

The antenna amplifier 31 is connected (electrically connected and the same applies below) to the antenna 1 through a signal line L1, and amplifies the signal from the antenna 1. Meanwhile, the antenna amplifier 32 is connected to the antenna 2 through the signal line L2, and amplifies the signal from the antenna 2.

The switching diode 33 is interposed in a signal line L31 (an example of a first signal line) connected to an output terminal T31 of the antenna amplifier 31, and switches between conduction and non-conduction of the signal line (signal route) L31 by way of switching on and off. Meanwhile, the switching diode 34 is interposed in a signal line L32 (an example of a second signal line) connected to an output terminal T32 of the antenna amplifier 32, and switches between conduction and non-conduction of the signal line L32 by way of switching on and off. Further, on/off of the switching diode 33 and the switching diode 34 depends on a direction of a direct current flowing in a coaxial cable 4, and has an inverse relationship from each other.

Furthermore, the antenna unit 3 has a connecting unit 35 which connects the signal line L31 and the signal line L32 after the switching diodes 33 and 34 are interposed. The connecting unit 35 is connected to the coaxial cable 4 through the signal line L3. Further, an anode of the switching diode 33 is connected to the output terminal T31 of the antenna amplifier 31 of the signal line L31, and a cathode of the switching diode 33 is connected to the connecting unit 35 of the signal line L31. By contrast with this, a cathode of the switching diode 34 is connected to the output terminal T32 of the antenna amplifier 32 of the signal line L32, and an anode of the switching diode 34 is connected to the connecting unit 35 of the signal line L32. That is, the switching diode 33 and the switching diode 34 have inverse polarities across the connecting unit 35.

Further, in the signal line L31 between the output terminal T31 of the antenna amplifier 31 and the switching diode 33, a capacitor C31 for blocking a direct current is interposed. In addition, a circuit configured by connecting the antenna amplifier 31 and the capacitor C31 in series is an example of a first circuit. Meanwhile, in the signal line L32 between the output terminal T32 of the antenna amplifier 32 and the switching diode 34, a capacitor C32 for blocking a direct current is interposed. In addition, a circuit configured by connecting the antenna amplifier 32 and the capacitor C32 in series is an example of a second circuit.

In addition, the antenna amplifiers 31 and 32 amplify signals of weak radio waves, and are not necessarily provided in the antenna unit 3. Further, the antenna unit 3 may be configured to have antenna matching circuits as first and second circuits instead of the antenna amplifiers 31 and 32 (or in combination with the antenna amplifiers 31 and 32). The antenna matching circuit refers to all circuits such as an impedance matching circuit, a filter circuit, a resonant circuit and an antiresonant circuit which are used to, for example, transmit received signals.

Further, in the antenna unit 3, the signal line L31 on the anode side of the switching diode 33 and the signal line L32 on the cathode side of the switching diode 34 are connected with a voltage-dividing circuit 36 through inductors (coils) 131 and 132 which each provide high impedances (that is, block high frequency alternate currents) with respect to a high frequency. A voltage (an example of a first voltage) Va(<Vcc) obtained by dividing a power source voltage (Vcc: an example of a second voltage) to half by the pressure-dividing circuit 36 is applied to the signal line L31 on the anode side of the switching diode 33 and the signal line L32 on the cathode side of the switching diode 34, respectively. In addition, this Va may not be ½ Vcc, and only needs to be a voltage (for example, about 0.6 to 0.7 V) at which the switching diodes 33 and 34 can be turned on and off.

Meanwhile, the tuner unit 5 receives through the coaxial cable 4 an input of a signal outputted from the antenna unit 3. The tuner unit 5 has, for example, a tuner 51 which receives a signal of a selected frequency, a diversity control unit 52, and a control circuit 53 which controls a direction of a direct current flowing in the coaxial cable 4.

The control circuit 53 is connected to a signal line L5 (an example of a third signal line) for connecting the coaxial cable 4 and the tuner 51 through a connecting unit 54. The control circuit 53 is configured to connect the signal line L5 and the power source Vcc through an inductor I53a and a current limiting resistance R53a (series circuit for I53a and R53a), and ground the signal line L5 through an inductor I53b, a current limiting resistance R53b and a transistor 53C (series circuit for I53b, R53b and 53c). The inductors I53a and I53b provide high impedances with respect to high frequencies. In addition, the transistor 53c is an example of a control switching element. Further, the control circuit 53 controls a direction of a direct current flowing in the coaxial cable 4 by controlling switching on and off of the transistor 53c. On/off of the transistor 53c is controlled by controlling a voltage (high or low level voltage) applied from the diversity control unit 52 to a base (gate) of the transistor 53c through the resistance R53d. That is, the diversity control unit 52 detects reception quality (the field intensity or a S/N ratio), and controls on/off of the transistor 53c by controlling the voltage based on this detection result. By this means, the antennas 1 and 2 are switched. That is, one of the antenna 1 and the antenna 2 is selected according to a direction of a direct current flowing in the coaxial cable 4. In addition, the transistor 53c may be a bipolar transistor or a field effect transistor (FET).

In addition, in the signal L5 between the connecting unit 54 and the tuner 51, a capacitor C51 for blocking a direct current is interposed.

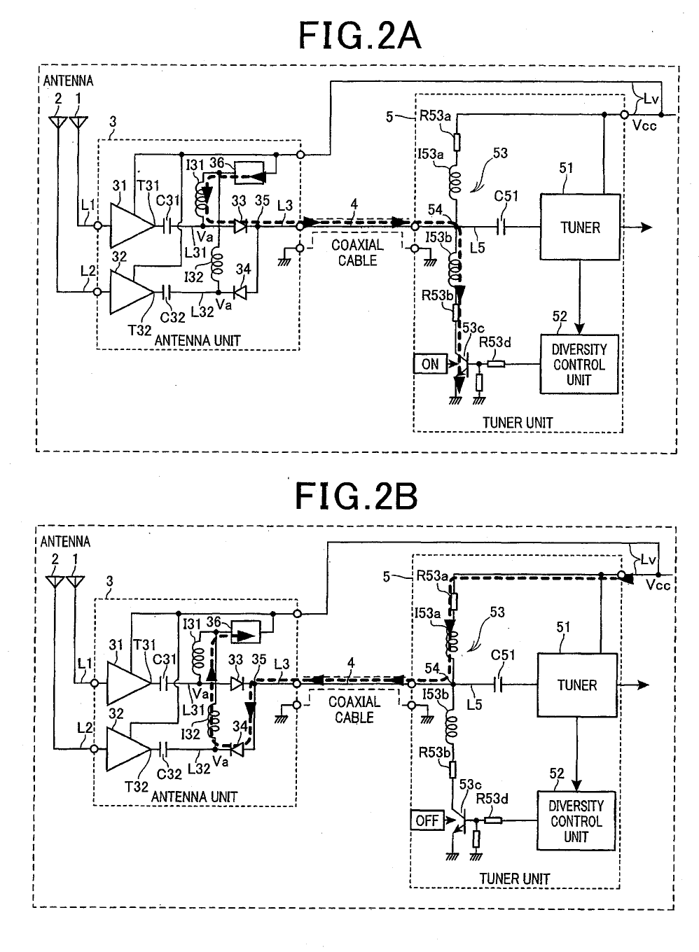

Next, an operation of the diversity receiver R according to the present embodiment will be described with reference to FIGS. 2A and 2B.

FIG. 2A illustrates a view that illustrates a route of a direct current flowing in the circuit in the diversity receiver R when the transistor 53c is in an on state. Meanwhile, FIG. 2B is a view that illustrates a route of a direct current flowing in a circuit in the diversity receiver R when the transistor 53c is in an off state.

First, when the antenna 1 is selected, a high level control voltage is outputted from the diversity control unit 52 in the tuner unit 5 to the base of the transistor 53c, and the transistor 53c is in the on state. In this state, as illustrated in FIG. 2A, a direct current flows from the antenna unit 3 to the tuner unit 5 (in an arrow direction) in the coaxial cable 4, and the switching diode 33 in the antenna unit 3 is in the on state, so that the signal line L31 is conducted. By this means, the signal received at the antenna 1 is amplified by the antenna amplifier 31, and is guided and inputted to the tuner 51 passing the signal L31, the switching diode 33, the signal line L3, the coaxial cable 4 and the signal line L5. In this case, the switching diode 34 is in the off state, so that the signal line L32 is not conducted.

By contrast with this, when, for example, reception quality of the antenna 1 becomes poor, the diversity control unit 52 switches the transistor 53c from on to off by outputting a low level control voltage to the base of the transistor 53c in order to select the antenna 2. Then, the power source Vcc appears in the connecting unit 54 through the inductor I53a and the resistance R53a. By contrast with this, the voltage of the cathode of the switching diode 34 in the antenna unit 3 is Va (for example, half of Vcc) applied from the pressure-dividing circuit 36, and, as illustrated in FIG. 2B, a direct current flows from the tuner unit 5 to the antenna unit 3 (in an arrow direction) in the coaxial cable 4 and the switching diode 34 in the antenna unit 3 is switched from off to on, so that the signal line L32 is switched from non-conduction to conduction. By this means, the signal received at the antenna 2 is amplified at the antenna amplifier 32, and is guided and inputted to the tuner 51 passing the signal line L32, the switching diode 34, the signal line L3, the coaxial cable 4 and the signal line L5. In this case, the switching diode 33 is switched from on to off, so that the signal line L31 is switched from conduction to non-conduction.

As described above, a configuration has been employed with the present embodiment where the switching diode 33 interposed in the signal line L31 which is a signal route from the antenna 1 and the switching diode 34 interposed in the signal line L32 which is the signal route from the antenna 2 are provided in the antenna unit 3 and the signal line L31 and the signal line L32 are connected after the switching diodes 33 and 34 are interposed and then connected to the coaxial cable 4, and on/off of the switching diode 34 depends on a direction of a direct current flowing in the coaxial cable 4 and has an inverse relationship from each other and the direction of the direct current flowing in the coaxial cable 4 is controlled by the control circuit 53 provided in the tuner unit 5, so that it is possible to reduce the number of coaxial cables 4 for transmitting signals received at a plurality of antennas from the antenna unit 3 to the tuner unit 5 without requiring a signal line for transmitting a predetermined control signal from the tuner unit 5 to the antenna unit 3. For example, in case of two antennas, one coaxial cable can make this configuration. Consequently, it is possible to reduce cost and weight.

Further, when the switching diodes 33 and 34 are configured to be simply provided in the antenna unit 3, and a direct current which is a control signal is superimposed on the coaxial cable 4 which is the same as a route for a signal received at the antenna 1 or 2, it is possible to control on/off of the switching diodes 33 and 34, and perform control to switch between the antennas 1 and 2.

Furthermore, according to the embodiment, it is possible to reduce the number of control switching elements provided for each coaxial cable in a conventional tuner unit.

In addition, although the switching diodes 33 and 34 are applied as examples of the first and second switching elements with the embodiment, transistors maybe applied as examples of the first and second switching elements.

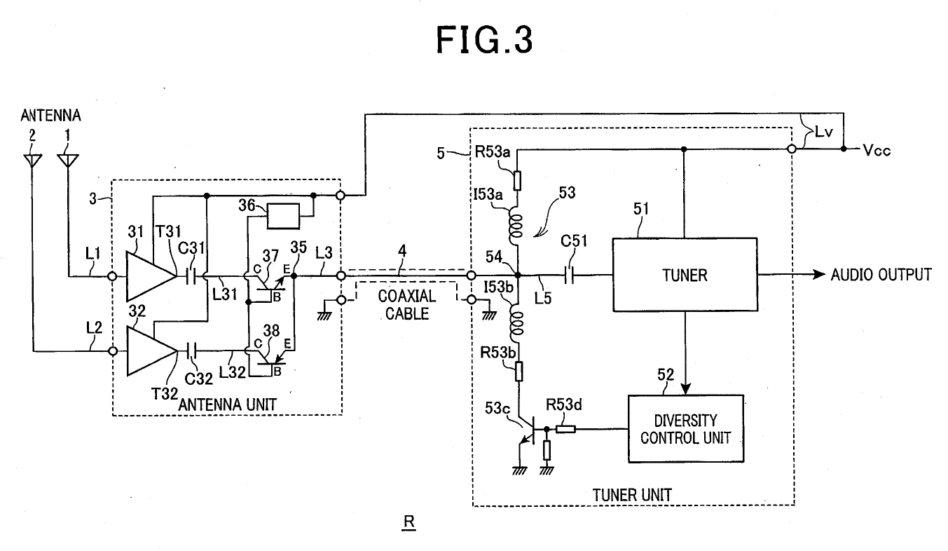

FIG. 3 illustrates a view that illustrates a configuration example of the diversity receiver when transistors are applied as first and second switching elements. In addition, with an example illustrated in FIG. 3, the same components as the components illustrated in FIG. 1 will be assigned the same reference numerals, and overlapping description thereof will be omitted.

With a diversity receiver R illustrated in FIG. 3, a npn transistor 37 which is a first switching element is applied, and a pnp transistor 38 which is a second switching element is applied.

The npn transistor 37 is interposed in the signal line L31 connected to the output terminal T31 of the antenna amplifier 31, and switches between conduction and non-conduction of the signal line L31 by way of switching on and off. By contrast with this, the pnp transistor 38 is interposed in the signal line L32 connected to the output terminal T32 of the antenna amplifier 32, and switches between conduction and non-conduction of the signal line L32 by way of switching on and off. Further, on/off of the npn transistor 37 and the pnp transistor 38 depends on a direction of a direct current flowing in the coaxial cable 4, and has an inverse relationship from each other.

Further, a collector of the npn transistor 37 is connected to the output terminal T31 of the antenna amplifier 31 of the signal line L31, and an emitter of the npn transistor 37 is connected to the connecting unit 35 of the signal line L31. Meanwhile, a collector of the pnp transistor 38 is connected to the output terminal T32 of the antenna amplifier 32 of the signal line L32, and an emitter of the pnp transistor 38 is connected to the connecting unit 35 of the signal line L32. Further, a base of the npn transistor 37 and a base of the pnp transistor 38 are electrically connected to the pressure dividing circuit 36.

With this configuration, when the transistor 53c is in the on state, a direct current flows from the antenna unit 3 to the tuner unit 5 in the coaxial cable 4, and the npn transistor 37 in the antenna unit 3 is in the on state (a forward bias is applied between the base and emitter of the npn transistor 37), so that the signal line L31 is conducted. By this means, a signal received at the antenna 1 is amplified by the antenna amplifier 31, and is guided and inputted to the tuner 51 passing the signal line L31, the npn transistor 37, the signal line L3, the coaxial cable 4 and the signal line L5. In this case, the pnp transistor 38 is in the off state, so that the signal line L32 is not conducted.

By contrast with this, when, for example, reception quality of the antenna 1 becomes poor, the diversity control unit 52 switches the transistor 53c from on to off, a direct current flows from the tuner unit 5 to the antenna unit 3 in the coaxial cable 4, and the pnp transistor 38 in the antenna unit 3 is switched from off to on, so that the signal line L32 is switched from non-conduction to conduction. By contrast with this, a signal received at the antenna 2 is amplified by the antenna amplifier 32, and is guided and inputted to the tuner 51 passing the signal line L32, the pnp transistor 38, the signal line L3, the coaxial cable 4 and the signal line L5. In this case, the pnp transistor 38 is switched from on to off, so that the signal line L31 is switched from conduction to non-conduction.

In addition, although the embodiment has been described using as an example a case where the diversity receiver has two antennas 1 and 2, the present invention is by no means limited to this, and, even when four or more (a multiple of two) antennas are provided, it is possible to apply the present invention per set of two antennas (for example, in case of four antennas, two coaxial cable can make the configuration).

### REFERENCE SIGNS LIST

1 ANTENNA
2 ANTENNA
3 ANTENNA UNIT
4 COAXIAL CABLE
5 TUNER UNIT
31 ANTENNA AMPLIFIER
32 ANTENNA AMPLIFIER
33 SWITCHING DIODE
34 SWITCHING DIODE
35 CONNECTING UNIT
36 VOLTAGE-DIVIDING CIRCUIT
37 npn TRANSISTOR
38 pnp TRANSISTOR
51 TUNER
52 DIVERSITY CONTROL UNIT
53 CONTROL CIRCUIT
54 CONNECTING UNIT
R DIVERSITY RECEIVER

1. A receiving apparatus comprising:
an antenna unit which receives inputs of signals received at a plurality of antennas; and
a tuner unit which receives an input of a signal outputted from the antenna unit through a coaxial cable,
wherein the antenna unit comprises:
a first circuit which is connected to a first antenna;
a second circuit which is connected to a second antenna;
a first switching element which is interposed in a first signal line connected to an output terminal of the first circuit, and which switches between conduction and non-conduction of the first signal line by way of switching on and off;
a second switching element which is interposed in a second signal line connected to an output terminal of the second circuit, and which switches between conduction and non-conduction of the second signal line by way of switching on and off; and
a connecting unit which connects the first signal line and the second signal line after each of the switching elements is interposed, and which is connected to the coaxial cable,
the switching on and off of the first switching element and the second switching element depends on a direction of a direct current flowing in the coaxial cable, and has an inverse relationship from each other, and
the tuner unit is connected to a third signal line which connects the coaxial cable and a tuner, and comprises a control circuit which controls the direction of the direct current flowing in the coaxial cable.

2. The receiving apparatus according to claim 1,
wherein the first switching element is a switching diode which comprises an anode of the switching diode connected to an output terminal of the first circuit of the first signal line, and a cathode of the switching diode connected to the connection unit of the first signal line, and
the second switching element is a switching diode which comprises a cathode of the switching diode connected to an output terminal of the second circuit of the second signal line, and an anode of the switching diode connected to the connection unit of the second signal line.

3. The receiving apparatus according to claim 2,
Wherein a first voltage is applied to the first signal line of the anode of the first switching element and the second signal line of the cathode of the second switching element, and
the control circuit connects the third signal line and a power source which supplies a second voltage higher than the first voltage through an inductor and a resistance, and grounds the third signal line through an inductor, a resistance and a control switching element, and controls a direction of a direct current flowing in the coaxial cable when switching on and off of the control switching element is controlled.

4. The receiving apparatus according to claim 1,
wherein the first switching element is a npn transistor which comprises a collector of the npn transistor connected to an output terminal of the first circuit of the first signal line, and an emitter of the npn transistor connected to the connecting unit of the first signal line, and
the second switching element is a pnp transistor which comprises a collector of the pnp transistor connected to an output terminal of the second circuit of the second signal line, and an emitter of the pnp transistor connected to the connecting unit of the second signal line.

5. The receiving apparatus according to claim 4,
wherein a first voltage is applied to a base of the npn transistor and a base of the pnp transistor, and
the control circuit connects the third signal line and a power source which supplies a second voltage higher than the first voltage through an inductor and a resistance, and grounds the third signal line through an inductor, a resistance and a control switching element, and controls a direction of a direct current flowing in the coaxial cable when switching on and off of the control switching element is controlled.

6. The receiving apparatus according to claim 1,
wherein the first circuit and the second circuit are configured by connecting in series an amplifier which amplifies the signals from the antennas, and a capacitor.

7. The receiving apparatus according to claim 2, wherein the first circuit and the second circuit are configured by connecting in series an amplifier which amplifies the signals from the antennas, and a capacitor.

8. The receiving apparatus according to claim 3, wherein the first circuit and the second circuit are configured by connecting in series an amplifier which amplifies the signals from the antennas, and a capacitor.

9. The receiving apparatus according to claim 4, wherein the first circuit and the second circuit are configured by connecting in series an amplifier which amplifies the signals from the antennas, and a capacitor.

10. The receiving apparatus according to claim 5, wherein the first circuit and the second circuit are configured by connecting in series an amplifier which amplifies the signals from the antennas, and a capacitor.
